(19) United States
(12) Patent Application Publication
(10) Pub. No.: US 2025/0379241 A1
(43) Pub. Date: Dec. 11, 2025

(54) FUEL CELL COOLING SYSTEM AND FUEL CELL TEMPERATURE CONTROL METHOD

(71) Applicant: AUTOMOTIVE RESEARCH & TESTING CENTER, CHANGHUA HSIEN (TW)

(72) Inventor: PO-HSU LIN, CHANGHUA HSIEN (TW)

(21) Appl. No.: 18/734,416

(22) Filed: Jun. 5, 2024

(51) Int. Cl. H01M 8/04014; H01M 8/04007; H01M 8/0432; H01M 8/04746; H01M 8/04858

(52) U.S. Cl. CPC H01M 8/04014; H01M 8/04074; H01M 8/04358; H01M 8/04768; H01M 8/04932; H01M 2250/20

(57) ABSTRACT

A fuel cell cooling system for a refrigerated vehicle has a first heat exchanger, a second heat exchanger, a coolant pump assembly, a solenoid valve module, and a control unit. The first heat exchanger and the second heat exchanger respectively exchange heat with air outside the refrigerated vehicle and air inside a refrigerated container. The coolant pump assembly allows a coolant to flow circularly. The solenoid valve module is electrically connected to the control unit. A fuel cell temperature control method is carried out by the control unit and has the following steps: receiving a power output adjusting data of the fuel cell system, computing an estimated temperature of the coolant according to the power output adjusting data, and determining whether the estimated temperature is within the temperature target range to control the solenoid valve module for controlling the operating temperature of the fuel cell system.

### BACKGROUND OF THE INVENTION

### 1. Field of the Invention

The present invention relates to a fuel cell vehicle, and particularly to a fuel cell cooling system and a fuel cell temperature control method for a refrigerated vehicle.

### 2. Description of Related Art

A fuel cell system features high efficiency and zero carbon emission and is thus applied to different kinds of vehicles to improve fuel efficiency and reduce air pollution. Electrical and thermal efficiencies of the system are highly related to an operating temperature of the fuel cell system; i.e., only when the operating temperature is in an appropriate range, the fuel cell system is able to have a stable output and optimize its effectiveness.

However, in a conventional fuel cell vehicle, the fuel cell system is normally integrated to a construction of a conventional vehicle, and a conventional cooling system on the conventional vehicle is directly modified for cooling the fuel cell system. Since the vehicle has a fixed space, volumes and numbers of heat exchangers and their fan units of the conventional cooling system are limited. Thereby, the operating temperature of the fuel cell system cannot be effectively controlled, which reduces the efficiency of the fuel cell system.

To overcome the aforementioned shortcomings, the present invention tends to provide a cooling system and a temperature control method for a fuel cell to mitigate or obviate the aforementioned problems.

### SUMMARY OF THE INVENTION

The main objective of the present invention is to provide a fuel cell cooling system and a fuel cell temperature control method that may assist in controlling the operating temperature of the fuel cell system via a feature of a refrigerated vehicle so as to improve the efficiency of the fuel cell system.

The fuel cell cooling system in accordance with the present invention is for a refrigerated vehicle having a fuel cell system and a refrigerated container. The fuel cell cooling system has a first heat exchanger, a second heat exchanger, a coolant pump assembly, a solenoid valve module, and a control unit. The first heat exchanger is configured to exchange heat with an air outside the refrigerated vehicle. The second heat exchanger is configured to exchange heat with an air inside the refrigerated container. The coolant pump assembly is configured to drive a coolant to flow circularly between the first heat exchanger and the fuel cell system. The solenoid valve module is disposed between the first heat exchanger and the second heat exchanger. The control unit is electrically connected to the solenoid valve module, stores a temperature target range, and is configured to receive a power output adjusting data, to compute an estimated temperature of the coolant according to the power output adjusting data, and to determine whether the estimated temperature is within the temperature target range. When the estimated temperature is within the temperature target range, the control unit controls the solenoid valve module to allow the coolant to flow from the first heat exchanger to the fuel cell system through the second heat exchanger. When the estimated temperature is out of the temperature target range, the control unit controls the solenoid valve module to allow the coolant to flow from the first heat exchanger to the fuel cell system without flowing through the second heat exchanger.

The fuel cell temperature control method in accordance with the present invention is for a vehicle having a fuel cell system, a refrigerated container, and a control unit storing a temperature target range. The fuel cell temperature control method is carried out by the control unit and has the following steps: receiving a power output adjusting data of the fuel cell system, computing an estimated temperature of a coolant according to the power output adjusting data, and determining whether the estimated temperature is within the temperature target range. When the estimated temperature is within the temperature target range, control a solenoid valve module to allow the coolant to flow from a first heat exchanger to the fuel cell system through a second heat exchanger disposed in the refrigerated container. When the estimated temperature is out of the temperature target range, control the solenoid valve module to allow the coolant to flow from the first heat exchanger to the fuel cell system without flowing through the second heat exchanger.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a fuel cell cooling system in accordance with the present invention applied in a refrigerated vehicle;

FIG. 2 is a schematic view of pipeline arrangement of the fuel cell cooling system in FIG. 1;

FIG. 3 is a system block diagram of electrical control for the fuel cell cooling system in FIG. 1;

FIGS. 4A and 4B are process flow diagrams of a fuel cell temperature control method carried out by a control unit of the fuel cell cooling system in FIGS. 1; and

FIGS. 5 and 6 are operational views of the fuel cell cooling system in FIG. 1.

### DETAILED DESCRIPTION OF THE PREFERRED EMBODIMENT

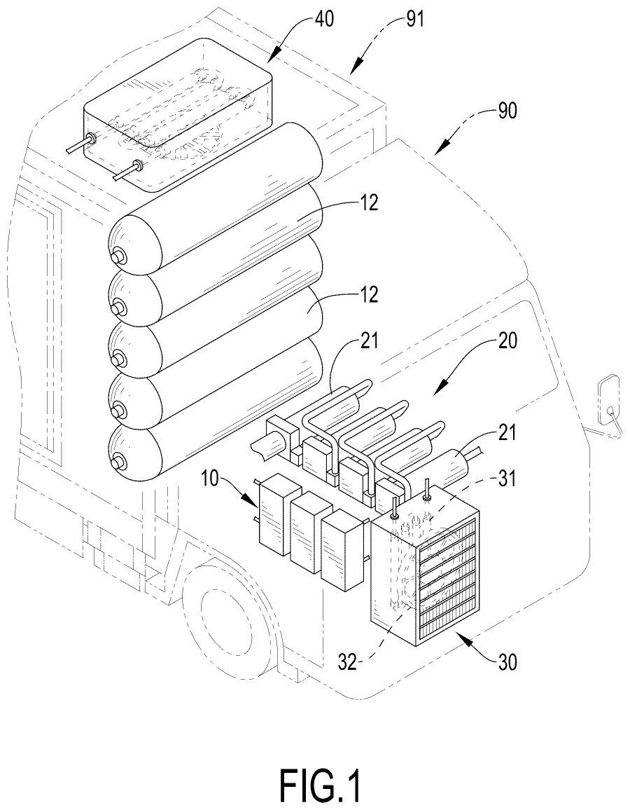

With reference to FIGS. 1 to 3, the present invention provides a fuel cell cooling system for a refrigerated vehicle 90. The refrigerated vehicle 90 has a fuel cell system 10 and a refrigerated container 91, wherein the refrigerated container 91 is a container being capable of keeping an interior temperature lower than room temperature to store cargos such as fresh foods or the likes that need to be kept fresh and in a lower temperature. The fuel cell cooling system is configured to control an operating temperature of the fuel cell system 10 and has a coolant pump assembly 20, a first heat exchanger 30, a second heat exchanger 40, a solenoid valve module 50, and a control unit 60.

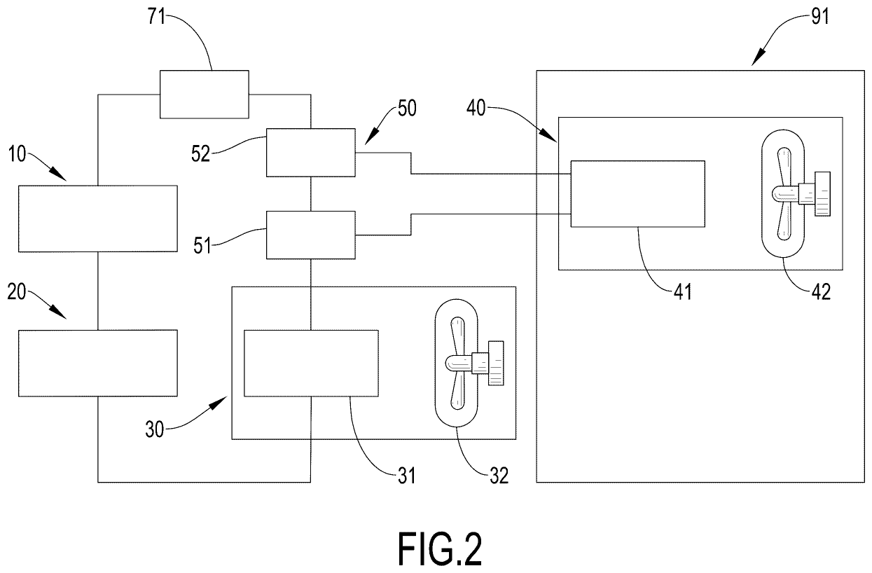

The fuel cell system 10 is configured to use hydrogen gas as a fuel for a chemical reaction to generate electricity, which is provided for a motor to drive the refrigerated vehicle 90 to move forward, is provided for a refrigeration system on the refrigerated vehicle 90 to control the interior temperature of the refrigerated container 91, and/or serves as a backup power source. With reference to FIG. 1, the refrigerated vehicle 90 has multiple hydrogen tanks 12 to supply hydrogen gas to the fuel cell system 10. Since the chemical reaction of the fuel cell system 10 produces heat, with reference to FIG. 2, the fuel cell cooling system has a coolant pipeline system for the coolant pump assembly 20, the first heat exchanger 30, the second heat exchanger 40, and the solenoid valve module 50 to be disposed thereon. Hence, a coolant may flow through the fuel cell system 10 for heat dissipation, lower the operating temperature of the fuel cell system 10, and be cooled down via the heat exchangers of the fuel cell cooling system for re-cooling the fuel cell system 10.

With reference to FIGS. 1 and 2, the coolant pump assembly 20 is configured to provide pressure such that the coolant can flow circularly in the coolant pipeline system between the first heat exchanger 30 and the fuel cell system 10. Specifically, the coolant pump assembly 20 has multiple coolant pumps 21 connected in series to ensure that the coolant has enough pressure to finish a cycle of flowing (i.e., to flow to the fuel cell system 10 for cooling after flowing through the first heat exchanger 30 from the fuel cell system 10 for being cooled) after being pumped from the fuel cell system 10.

With reference to FIG. 2, specifically, the first heat exchanger 30 has a first exchanging unit 31 and a first fan unit 32. The first exchanging unit 31 can be pipes or the likes configured for the coolant to flow therethrough. The first exchanging unit 31 is connected to the coolant pump assembly 20, and the coolant is pumped to flow through the first exchanging unit 31. The first fan unit 32 is disposed aside the first exchanging unit 31 and communicates with an exterior of the refrigerated vehicle 90. The first fan unit 32 is configured to drive air outside the refrigerated vehicle 90 to enter the refrigerated vehicle 90 and to exchange heat with the first exchanging unit 31, which allows the coolant flowing through the first exchanging unit 31 to be cooled down.

With reference to FIGS. 1 and 2, the second heat exchanger 40 is disposed inside the refrigerated container 91 of the refrigerated vehicle 90 and has a second exchanging unit 41 and a second fan unit 42. The second exchanging unit 41 can be pipes or the likes configured for the coolant to flow therethrough, and the second fan unit 42 is disposed aside the second exchanging unit 41. The second fan unit 42 is configured to drive air inside the refrigerated container 91 to exchange heat with the second exchanging unit 41, which allows the coolant flowing through the second exchanging unit 41 to be cooled down.

Details and configurations of the exchanging unit, the fan unit, and other components of the first heat exchanger 30 and the second heat exchanger 40 may refer to conventional techniques of heat exchanger or adopt a cooling system in a conventional vehicle; e.g., each one of the first heat exchanger 30 and the second heat exchanger 40 may have multiple said fan units. Configurations of the first heat exchanger 30 and the second heat exchanger 40 are not specifically limited in the preferred embodiment.

With reference to FIG. 2, the solenoid valve module 50 has a first solenoid valve 51 and a second solenoid valve 52. The first solenoid valve 51 is disposed between the first exchanging unit 31 of the first heat exchanger 30 and the second exchanging unit 41 of the second heat exchanger 40. The first solenoid valve 51 is controllable to decide whether the coolant can flow through the second heat exchanger 40 after flowing through the first heat exchanger 30. The second solenoid valve 52 is disposed between the first solenoid valve 51, the second exchanging unit 41, and the fuel cell system 10. The second solenoid valve 52 is controllable to allow the coolant to flow to the fuel cell system 10 from the first solenoid valve 51 or from the second exchanging unit 41 according to a state of the first solenoid valve 51.

In other embodiments, the solenoid valve module 50 may have a three-way pipe instead of the second solenoid valve 52 and have a check valve disposed between the three-way pipe and the second exchanging unit 41. After the first solenoid valve 51 is controlled to switch the coolant's path, the three-way pipe and the check valve also allow the coolant to flow to the fuel cell system 10 along the same path as adopting the second solenoid valve 52. As long as the solenoid valve module 50 has the first solenoid valve 51 to decide whether the coolant flows through the second heat exchanger 40 after flowing through the first heat exchanger 30, configurations of the solenoid valve module 50 in the rear of the first solenoid valve 51 are not limited to the preferred embodiment.

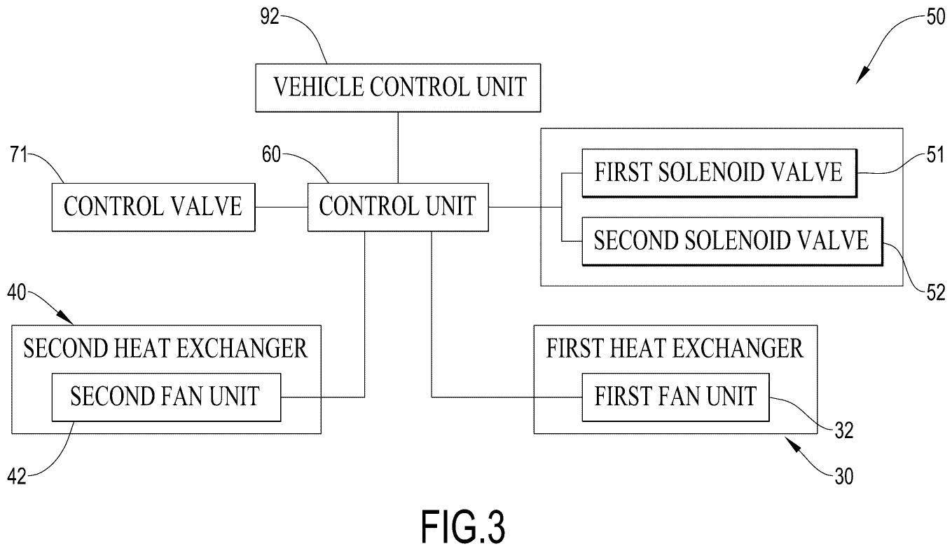

With reference to FIG. 3, the control unit 60 is electrically connected to the first solenoid valve 51 and the second solenoid valve 52 and stores a temperature target range therein. Specifically, the control unit 60 may be a microcontroller unit (MCU) or the likes configured for storing data and computing. In the preferred embodiment, the refrigerated vehicle 90 has a vehicle control unit 92 (VCU). The control unit 60 is electrically connected to the vehicle control unit 92 and configured to receive a data of a corresponding command, to compute according to the data, and to compare a computing result with the temperature target range so as to control the first solenoid valve 51 and the second solenoid valve 52 and to decide the coolant's path.

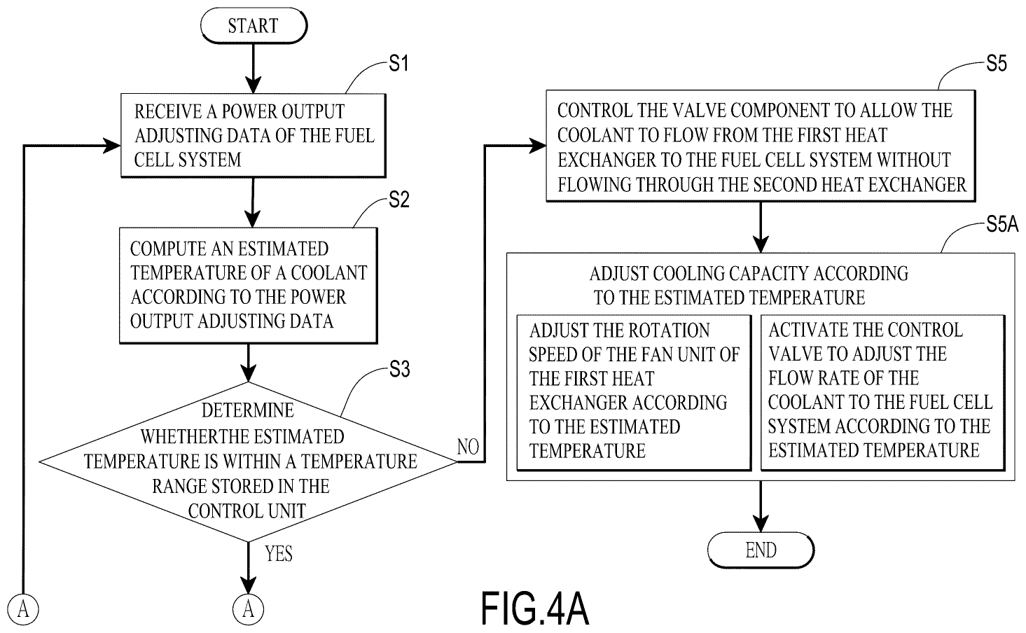

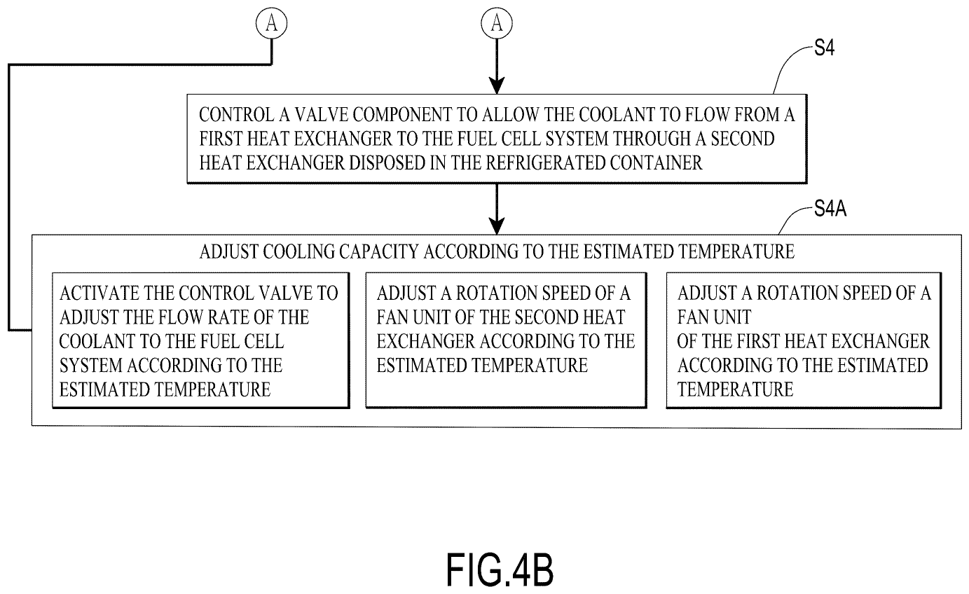

With reference to FIGS. 4A and 4B, a process of a fuel cell temperature control method executed in the fuel cell cooling system is shown. The fuel cell temperature control method is carried out by the control unit 60 during the refrigerated vehicle 90 running and has the following steps:

A data receiving step S1: at first, receiving a power output adjusting data of the fuel cell system 10. Specifically, when the refrigerated vehicle 90 needs to increase a power output of the fuel cell system 10 (e.g., when the refrigerated vehicle 90 needs to speed up), the vehicle control unit 92 receives a power output adjusting command to adjust the power output of the fuel cell system 10. Specifically, the vehicle control unit 92 may send an electrical signal to activate an air valve so as to adjust an amount of the hydrogen gas supplied to the fuel cell system 10 from the hydrogen tanks 12; thereby, the power output of the fuel cell system 10 can be increased. After the vehicle control unit 92 receives the power output adjusting command, the vehicle control unit 92 sends the power output adjusting data according to the power output adjusting command. The control unit 60 then receives the power output adjusting data to acquire a present power output and a target power output of the fuel cell system 10.

A computing step S2: then, computing an estimated temperature of the coolant according to the power output adjusting data. Specifically, a fuel cell may have characteristic curves related to system efficiency, power output, temperature, and other properties according to its features. The control unit 60 stores operational expressions based on the characteristic curves of the fuel cell system 10 therein. After the control unit 60 receives the power output adjusting data, the control unit 60 first computes a present heat of the fuel cell system 10 dissipated by the coolant according to the present power output of the fuel cell system 10 and the operational expressions, and computes an estimated heat of the fuel cell system 10 dissipated by the coolant according to the target power output of the fuel cell system 10 and the operational expressions. Next, the control unit 60 compares the present heat and the estimated heat to compute an extra heat due to increase of the power output of the fuel cell system 10. Afterwards, the control unit 60 is able to compute the estimated temperature of the coolant flowing through the fuel cell system 10 according to the extra heat, a present temperature of the coolant flowing through the fuel cell system 10, and a flow rate of the coolant.

In the description above, the present temperature of the coolant can be acquired via a temperature sensor disposed in the rear of the fuel cell system 10. With reference to the flow rate of the coolant, a flow meter may be disposed on the coolant pipeline system, sense a flow rate data of the coolant, and send the flow rate data to the control unit 60, or the control unit 60 may receive rotation speed data of the coolant pumps 21 and compute the flow rate according to the rotation speed data. In addition, the coolant pump assembly 20 may adopt the coolant pumps 21 having fixed rotation speeds, and the flow rate can be calculated first and stored in the control unit 60. The above-mentioned means all allow the control unit 60 to acquire the flow rate of the coolant, which enables the control unit 60 to compute the estimated temperature as described above.

A determining step S3: afterwards, determining whether the estimated temperature is within the temperature target range stored in the control unit 60. After computing the estimated temperature, the control unit 60 further computes to determine whether the estimated temperature falls into the temperature target range stored therein so as to decide the coolant's path. Thereby, the coolant is able to be cooled down via appropriate means at an appropriate time.

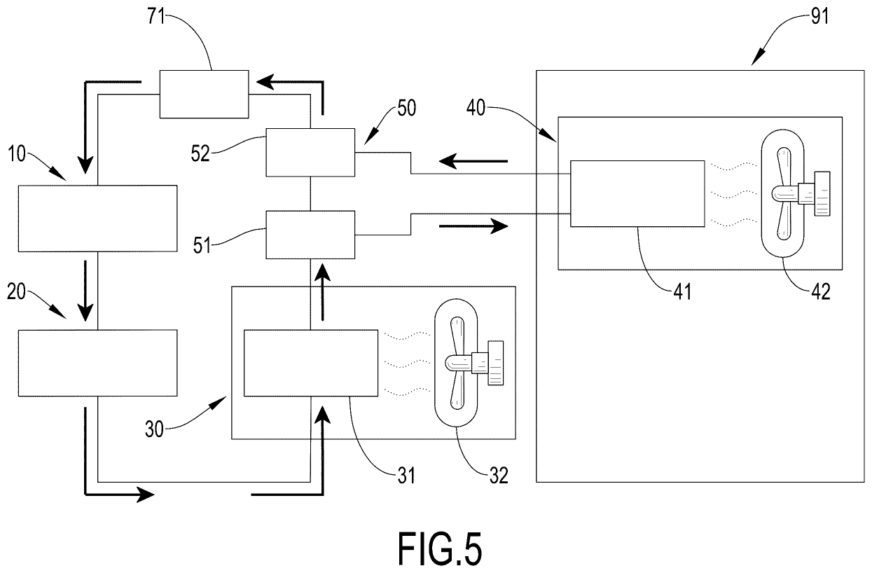

With reference to FIGS. 4A and 4B, when the control unit 60 determines that the estimated temperature is within the temperature target range, the control unit 60 then carries out a forced cooling step S4: controlling the solenoid valve module 50 to allow the coolant to flow from the first heat exchanger 30 to the fuel cell system 10 through the second heat exchanger 40 disposed in the refrigerated container 91. When the estimated temperature is within the temperature target range, this means a difference between the estimated temperature and the present temperature of the coolant is in a controllable range. With reference to FIG. 5, the control unit 60 sends electrical signals to control the first solenoid valve 51 and the second solenoid valve 52 so as to allow the coolant to flow through the second exchanging unit 41 and to be cooled by refrigerated air in the refrigerated container 91 after being cooled by the first heat exchanger 30. Thereby, the coolant can further be cooled by the second heat exchanger 40 in the refrigerated container 91 after being conventionally cooled by the first heat exchanger 30, which forces a temperature of the coolant to be lowered quickly. Afterwards, the coolant flows to and cools the fuel cell system 10 again, which can effectively keep the operating temperature of the fuel cell system 10 at a lower state.

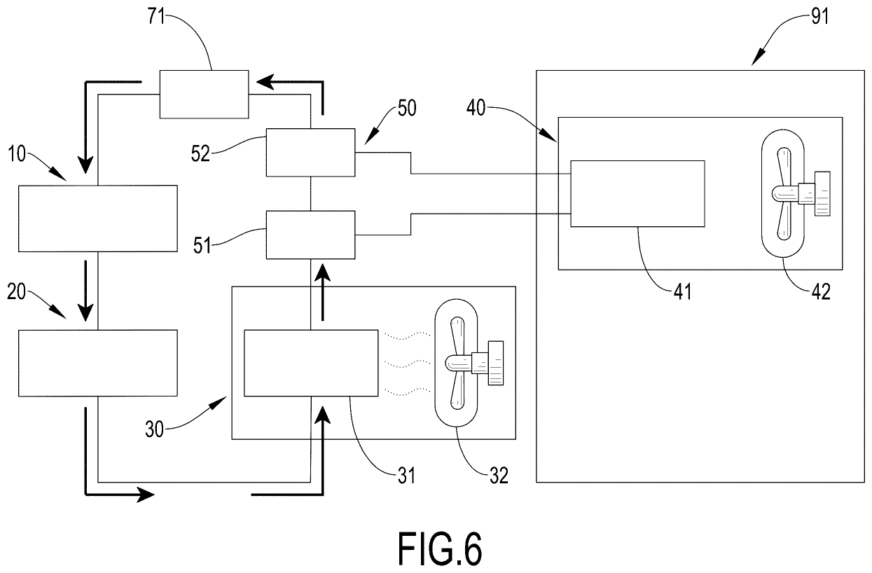

With reference to FIG. 4A, when the control unit 60 determines that the estimated temperature is out of the temperature target range, the control unit 60 carries out a conventional cooling step S5: controlling the solenoid valve module 50 to allow the coolant to flow from the first heat exchanger 30 to the fuel cell system 10 without flowing through the second heat exchanger 40. When the estimated temperature is out of the temperature target range, this means the temperature of the coolant increases too much after flowing through the fuel cell system 10 reaching the target power output. With reference to FIG. 6, at the time, the control unit 60 sends electrical signals to control the first solenoid valve 51 and the second solenoid valve 52 so as to allow the coolant to directly flow to the fuel cell system 10 after being cooled by the first heat exchanger 30 without flowing through the second heat exchanger 40. Thereby, when the coolant is estimated to have a high temperature rise, the coolant is conventionally cooled by the first heat exchanger 30 only, which prevents the interior temperature of the refrigerated container 91 from over-rising due to the coolant with a high temperature.

According to the paragraphs described above, the fuel cell cooling system and the corresponding fuel cell temperature control method in accordance with the present invention allow the coolant to be forcedly cooled by the second heat exchanger 40 in the refrigerated container 91 after being cooled by the conventional first heat exchanger 30 when the power output of the fuel cell system 10 is consistent or slightly adjusted, which maintains the coolant at a lower temperature. When the power output of the fuel cell system 10 is substantially increased, the coolant with the lower temperature can effectively transfer extra heat produced by increase of the power output of the fuel cell system 10. Hence, the operating temperature of the fuel cell system 10 can be controlled and may not increase too fast, which allows the fuel cell system 10 to maintain great working efficiency and to provide its great electrical and thermal efficiencies.

Additionally, after the power output of the fuel cell system 10 is highly increased, the determining process of the control unit 60 stops the coolant from being cooled by the second heat exchanger 40 in the refrigerated container 91, which prevents the interior temperature of the refrigerated container 91 from over-rising due to the coolant with high temperature and prevents the commodities in the refrigerated container 91 from staleness or spoiling. Accordingly, the present invention assists in cooling the coolant via the refrigerated container 91 without interfering with the original storing function of the refrigerated container 91.

With reference to FIGS. 2 and 3, in the preferred embodiment, the fuel cell cooling system further has a control valve 71. The control valve 71 is disposed to the coolant pipeline system and between the second solenoid 52 and the fuel cell system 10. The control valve 71 is electrically connected to the control unit 60 and is controllable by the control unit 60 to adjust a flow rate of the coolant from a coolant tank, into the coolant pipeline system, and toward the fuel cell system 10. The coolant tank in a vehicle is conventional and is thus not shown in the figures and not described in details.

With reference to FIGS. 4A and 4B, in the fuel cell temperature control method described above, a first adjusting step S4A and a second adjusting step S5A are respectively carried out after the forced cooling step S4 and the second cooling step S5 to adjust a heat dissipation capacity of the fuel cell system 10 according to the estimated temperature. Specifically, each one of the first adjusting step S4A and the second adjusting step S5A includes: activating the control valve 71 to adjust the flow rate of the coolant to the fuel cell system 10 according to the estimated temperature. After the control unit 60 computes the extra heat of the fuel cell system 10, the control unit 60 sends an electrical signal to control the control valve 71 so as to adjust the flow rate of the coolant to the fuel cell system 10 for adjusting the heat dissipation capacity to the fuel cell system 10, which allows the operating temperature of the fuel cell system 10 to be controlled more effectively.

With reference to FIGS. 4A and 4B, further, in the preferred embodiment, after the forced cooling step S4, the control unit 60 repeats the data receiving step S1. The control unit 60 re-receives the power output adjusting data of the fuel cell system 10; thereby, the control unit 60 is able to constantly and promptly adjust the coolant's path according to adjustment of the power output of the fuel cell system 10, which allows the coolant to transfer the extra heat from the fuel cell system 10 more quickly and allows the fuel cell system 10 to further work in a better efficiency.

In the preferred embodiment, the second fan unit 42 of the second heat exchanger 40 is a fan having an adjustable rotation speed. With reference to FIG. 3, the second fan unit 42 is electrically connected to the control unit 60 and is controllable by the control unit 60 to adjust its rotation speed. Specifically, with reference to FIG. 4, the first adjusting step S4A further includes: adjusting a rotation speed of a fan unit of the second heat exchanger 40 (i.e., the second fan unit 42) according to the estimated temperature. After the control unit 60 computes the extra heat of the fuel cell system 10, the control unit 60 adjusts the rotation speed of the second fan unit 42 to adjust heat exchange efficiency of the second heat exchanger 40. Therefore, the coolant can be effectively cooled at the second heat exchanger 40 and then flow to the fuel cell system 10 again, which improves the heat dissipation capacity to the fuel cell system 10 and allows the operating temperature of the fuel cell system 10 to be controlled more stably.

In the preferred embodiment, the first fan unit 32 of the first heat exchanger 30 is also a fan having an adjustable rotation speed. With reference to FIG. 3, the first fan unit 32 is electrically connected to the control unit 60 and is controllable by the control unit 60 to adjust its rotation speed. Specifically, with reference to FIGS. 4A and 4B, each one of the first adjusting step S4A and the second adjusting step S5A further includes: adjusting a rotation speed of a fan unit of the first heat exchanger 30 (i.e., the first fan unit 32) according to the estimated temperature. After the control unit 60 computes the extra heat of the fuel cell system 10, the control unit 60 adjusts the rotation speed of the first fan unit 32 to adjust heat exchange efficiency of the first heat exchanger 30. Thereby, the operating temperature of fuel cell system 10 can be controlled more stably as description of the second fan unit 42.

With reference to FIGS. 4A and 4B, as described above, the first adjusting step S4A and the second adjusting step S5A include the following operation details: activating the control valve 71 to adjust the flow rate of the coolant to the fuel cell system 10 according to the estimated temperature, adjusting the rotation speed of the first fan unit 32 according to the estimated temperature, and adjusting the rotation speed of the second fan unit 42 according to the estimated temperature. When the first adjusting step S4A or the second adjusting step S5A is carried out, either all the operation details or at least one of the operation details may be put into action according to the estimated temperature of the coolant, which is not particularly limited in the preferred embodiment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fuel cell cooling system for a refrigerated vehicle, the refrigerated vehicle comprising a fuel cell system and a refrigerated container; the fuel cell cooling system comprising:
a first heat exchanger configured to exchange heat with air outside the refrigerated vehicle;
a second heat exchanger configured to exchange heat with air inside the refrigerated container;
a coolant pump assembly configured to drive a coolant to flow circularly between the first heat exchanger and the fuel cell system;
a solenoid valve module disposed between the first heat exchanger and the second heat exchanger; and
a control unit electrically connected to the solenoid valve module, storing a temperature target range, and configured to receive a power output adjusting data, to compute an estimated temperature of the coolant according to the power output adjusting data, and to determine whether the estimated temperature is within the temperature target range;
wherein when the estimated temperature is within the temperature target range, the control unit controls the solenoid valve module to allow the coolant to flow from the first heat exchanger to the fuel cell system through the second heat exchanger;
when the estimated temperature is out of the temperature target range, the control unit controls the solenoid valve module to allow the coolant to flow from the first heat exchanger to the fuel cell system without flowing through the second heat exchanger.

2. The fuel cell cooling system as claimed in claim 1, wherein the cooling system has a control valve electrically connected to the control unit and being controllable by the control unit to adjust a flow rate of the coolant to the fuel cell system.

3. The fuel cell cooling system as claimed in claim 1, wherein the second heat exchanger has
an exchanging unit; and
at least one fan unit disposed aside the exchanging unit, electrically connected to the control unit, and being controllable by the control unit to adjust a rotation speed thereof.

4. The fuel cell cooling system as claimed in claim 1, wherein the first heat exchanger has
an exchanging unit; and
at least one fan unit disposed aside the exchanging unit, electrically connected to the control unit, and being controllable by the control unit to adjust a rotation speed thereof.

5. A fuel cell temperature control method for a vehicle, the vehicle comprising a fuel cell system, a refrigerated container, and a control unit storing a temperature target range; the control method carried out by the control unit and comprising the following steps:
receiving a power output adjusting data of the fuel cell system;
computing an estimated temperature of a coolant according to the power output adjusting data; and
determining whether the estimated temperature is within the temperature target range;
when the estimated temperature is within the temperature target range, controlling a solenoid valve module to allow the coolant to flow from a first heat exchanger to the fuel cell system through a second heat exchanger disposed in the refrigerated container; and
when the estimated temperature is out of the temperature target range, controlling the solenoid valve module to allow the coolant to flow from the first heat exchanger to the fuel cell system without flowing through the second heat exchanger.

6. The fuel cell temperature control method as claimed in claim 5, wherein after controlling the solenoid valve module to allow the coolant to flow from the first heat exchanger to the fuel cell system through the second heat exchanger, the control unit adjusts a rotation speed of a fan unit of the second heat exchanger to adjust a heat exchange efficiency of the second heat exchanger.

7. The fuel cell temperature control method as claimed in claim 5, wherein the control unit activates a control valve to adjust a flow rate of the coolant to the fuel cell system according to the estimated temperature.

8. The fuel cell temperature control method as claimed in claim 5, wherein the control unit adjusts a rotation speed of a fan unit of the first heat exchanger to adjust a heat exchange efficiency of the first heat exchanger.

9. The fuel cell temperature control method as claimed in claim 5, wherein after the coolant flows to the fuel cell system through the second heat exchanger in the refrigerated container, the control unit re-receives the power output adjusting data of the fuel cell system.
